(19) United States
(12) Patent Application Publication
(10) Pub. No.: US 2013/0231991 A1
(43) Pub. Date: Sep. 5, 2013

(54) APPARATUS, METHOD, AND SYSTEM FOR CONDUCTING A TRANSACTION

(71) Applicant: INGERSOLL-RAND COMPANY, Davidson, NC (US)

(72) Inventor: Aine Denari, Carmel, IN (US)

(21) Appl. No.: 13/786,168

(22) Filed: Mar. 5, 2013

Related U.S. Application Data
(60) Provisional application No. 61/606,802, filed on Mar. 5, 2012.

(51) Int. Cl. G06Q 30/02

(52) U.S. Cl. CPC G06Q 30/0222
USPC 705/14.23

(57) ABSTRACT

A computing device is configured to receive an order from a customer to purchase one or more devices. The computing device is configured to determine a discount. The computing device is further configured to generate a transaction for the purchase including the discount. The computing device is further configured to provide the transaction to the customer.

### CROSS-REFERENCE TO RELATED APPLICATIONS

The present application claims the benefit of U.S. Provisional Patent Application No. 61/606,802, filed on Mar. 5, 2012, which is hereby incorporated by reference in its entirety.

### BACKGROUND

The present application generally relates to transactions, and more particularly, but not exclusively, relates to conducting transactions. Transactions involving the sale of products may be carried out in a variety of ways. Some existing systems have various shortcomings relative to certain applications. Accordingly, there remains a need for further contributions in this area of technology.

### SUMMARY

One embodiment of the present application is a unique transaction system. Other embodiments include apparatuses, systems, devices, hardware, methods, and combinations for transactions. Further embodiments, forms, features, aspects, benefits, and advantages of the present application shall become apparent from the description and figures provided herewith.

### BRIEF DESCRIPTION OF THE FIGURES

The description herein makes reference to the accompanying figures wherein like reference numerals refer to like parts throughout the several views, and wherein:

FIG. 1 is a schematic block diagram of an exemplary system.

FIG. 2 is a schematic block diagram of an exemplary computing device.

FIG. 3 is a schematic flow diagram of an exemplary process for conducting a transaction.

### DETAILED DESCRIPTION OF REPRESENTATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

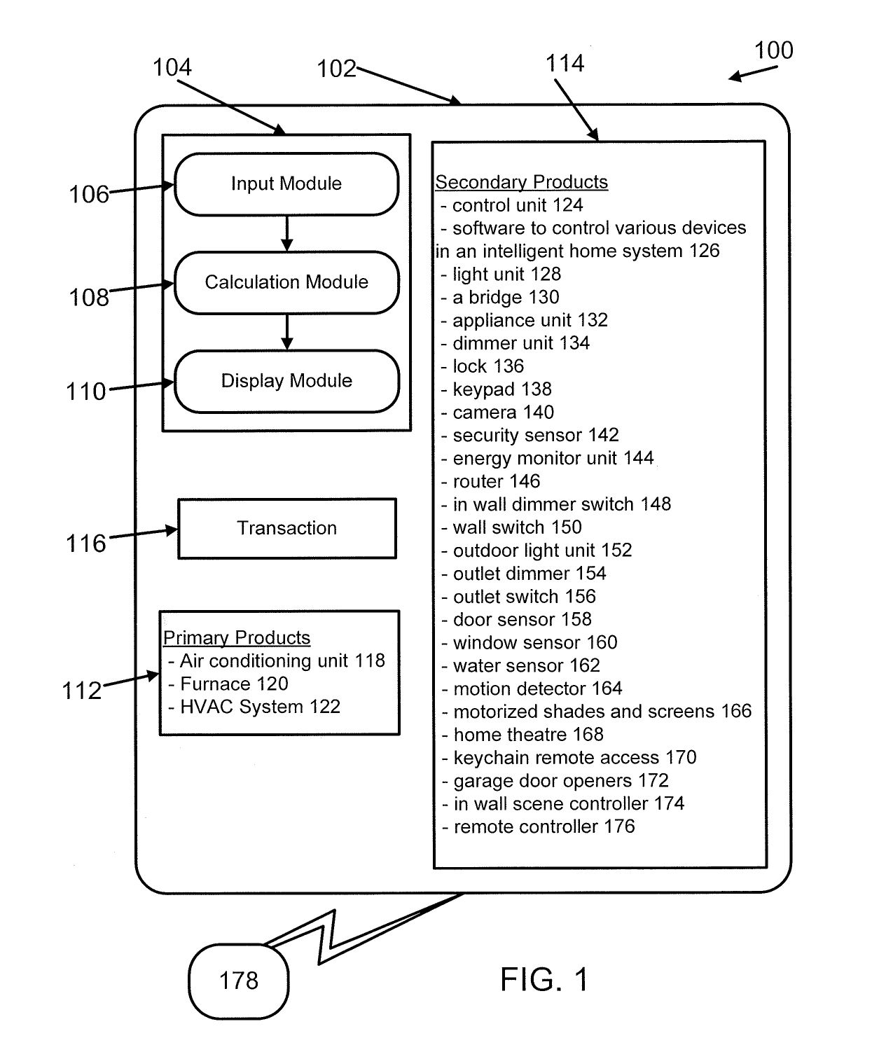

FIG. 1 illustrates an exemplary system 100 including a computing device 102. The computing device 102 may be any type of computer such as laptop computer, a desktop computer, a tablet computer, a server, a mobile phone, and/or any other type of computing device. The computing device 102 includes a processing subsystem 104, which may be part of operating logic executed by a processing device.

The exemplary embodiments described herein may include a number of modules providing a number of functionalities. A module may be implemented as operations by software, hardware, artificial intelligence, fuzzy logic, or any combination thereof, or at least partially performed by a user or operator. In certain embodiments, modules represent software elements as a computer program encoded on a computer readable storage medium, wherein a computer performs the described operations when executing the computer program. A module may be a single device, distributed across devices, and/or a module may be grouped in whole or in part with other modules or devices. The operations of any module may be performed wholly or partially in hardware/software or by other modules. The presented organization of the modules is exemplary only, and other organizations, configurations and arrangements are contemplated.

The processing subsystem 104 includes an input module 106, a calculation module 108, and a display module 110. It is contemplated that the computing device 102 and/or processing subsystem 104 include other modules. The computing device 102 may be used by a seller (e.g., a manufacturer) to conduct transactions and sales with customers such as dealers and other purchasers of equipment and/or services.

The input module 106 is structured to receive input from a user or another device related to a sale of one or more products. For example, an employee of the seller may input the information into the computing device 102. As another example, the seller's computing device 102 may receive the order electronically from the customer's computing device. Moreover, the input may include information about the type of product(s) to be purchased. The information also includes the quantity of the product of that a customer (e.g., a dealer), for example, wishes to purchase.

This information may be stored in or selected from a primary products file 112 that includes information about primary products and/or a secondary products file 114 that includes information about secondary products. It is contemplated that the information in the primary products file 112 and the secondary products file 114 may be stored in one file or multiple files. Furthermore, it is contemplated that the information in the primary products file 112 and the secondary products file 114 may be stored in a database, a spreadsheet, and/or any other appropriate means known to those skilled in the art.

After the information related to the sale is identified and/or selected in the files 112 and 114, the calculation module 108 uses the products selected and the quantity to generate a transaction 116. The transaction 116 may be a contract, an agreement, a purchase order, or the like. The transaction 116 may include other products not selected by the customer (e.g., a dealer), but are identified by the calculation module 108 as related to or potentially desirable to the dealer or user of the products.

The products shown in files 112 and 114 are generally devices and/or services related to heating, ventilation, and air conditioning (HVAC) systems and/or home security. Generally, the secondary products enhance, complement, and/or supplement the primary products. It is contemplated that products may be placed into either category for a given application. As shown in FIG. 1, the primary products may include an air conditioning unit 118, a furnace 120, and a HVAC system 122. Other primary products are contemplated.

The secondary products may include a control unit 124 to control the climate in the home (such as a thermostat and HVAC control) and/or control any of the other products listed in files 112 and 114. The secondary products may also include a software application 126 to control, in some embodiments, remotely, various devices in an intelligent home system. In some embodiments, the software application 126 operates on a mobile phone (e.g., a smartphone) or a tablet computer. In some embodiments, the software application 126 is a web application that is accessible on the Internet.

The secondary products may further include a light unit 128 (which allows the turning on and off of lights to be controlled by the control unit 124 or software 126), a bridge 130 (which receives and transmits wireless or wired control and/or status signals for products in files 112 and 114), an appliance unit 132 (which allows appliances to be controlled), a dimmer unit 134 (for controlled dimming of lights), a lock 136 (such as for a door or window), a keypad 138 (for a door), a camera 140 (for taking pictures or recording video), a security sensor 142 (e.g., a motion sensor), an energy monitor unit 144 (for measuring the amount of electricity used by devices in a home), a router 146, an in-wall dimmer switch 148, a wall switch 150, an outdoor light unit 152, an outlet dimmer 154, an outlet switch 156, a door sensor 158 (e.g., a door position sensor or a tamper sensor), a window sensor 160 (e.g., a position sensor or a tamper sensor), a water sensor 162, a motion detector 164, motorized shades and screens 166, a home theatre 168, a keychain remote access 170, garage door openers 172, an in wall scene controller 174, and/or a remote controller 176. Additionally, the various products, including but not limited to the light unit 128, the lock 136, and/or the appliance unit 132, may act as “repeaters” and propagate the control signals to other devices.

The primary and secondary products may be integrated into an electronic intelligent home system and controlled by the control unit 124 and/or software application 126 on a mobile phone (e.g., a smartphone) or tablet computer, and/or over the Internet. Moreover, all the secondary devices may be connected by a wireless or wired connection to one another or to the control unit 124 or software application 126.

In one exemplary embodiment, the transaction 116 generated by the calculation module 108 includes a HVAC system bundled with a connected control starter package including a control unit 124 (including a thermostat), a light unit 128, a bridge 130, and a six-month subscription to the software 126. In one embodiment, the secondary products in the bundled transaction 116 are provided at a relatively substantial discount. The amount of discount is based on upon, among other things, the inclusion rate (e.g., 50%, 80%, 100%) of the dealer. For example, the more the dealer invests in primary and/or secondary products and sells them to consumers, the discount provided by the manufacturer will generally be larger. The discount may be reflected as an amount of money off of the price of the product(s) or a percentage or rate that reduces the purchase price. In one embodiment, the discount is based on the quantity of primary products the dealer purchases. In some embodiments, the discount may be directly proportional to the number of primary products purchased. In other embodiments, the discount is inversely proportional to the number of primary products purchased. Other forms of discounts are contemplated.

After the calculation module 108 has generated the transaction 116 and populated the transaction 116 with information such as terms, quantity, and/or discount rate, among other things, the display module 110 may publish or display the transaction 116 by emailing the transaction 116 or otherwise transmitting the transaction 116 to a customer computing device 178. The display module 110 of the computing device 102 may display the transaction 116, which includes displaying the transaction 116 on a screen of the computing device, emailing the transaction 116 to the customer computing device 178, emailing the transaction 116 to other computing devices at the seller, uploading the transaction 116 to a web portal, printing the transaction 116 and/or providing the transaction 116 to the customer in any other suitable way known to those skilled in the art. Moreover, the display module 110 transforms the transaction 116 and/or information related to the transaction 116 into a format or arrangement that is intelligible and perceptible by a user of the computing device 102. The transaction 116 may be displayed before or after the transaction has been agreed to by the seller and the customer.

The computing device 102 may also be configured to manage product manufacturing and/or product inventory based on the number of primary products ordered. For example, allocating a portion of the inventory based on the number of primary products in the order. As another example, the manufacturing output of primary products may be increased or decreased based on the number of primary products in the order. It is contemplated that a computing device other than the computing device 102 may manage some or all of the product manufacturing and/or product inventory. It is contemplated that the calculation module 108 of the computing device 102 may perform some or all of the management of manufacturing and/or inventory.

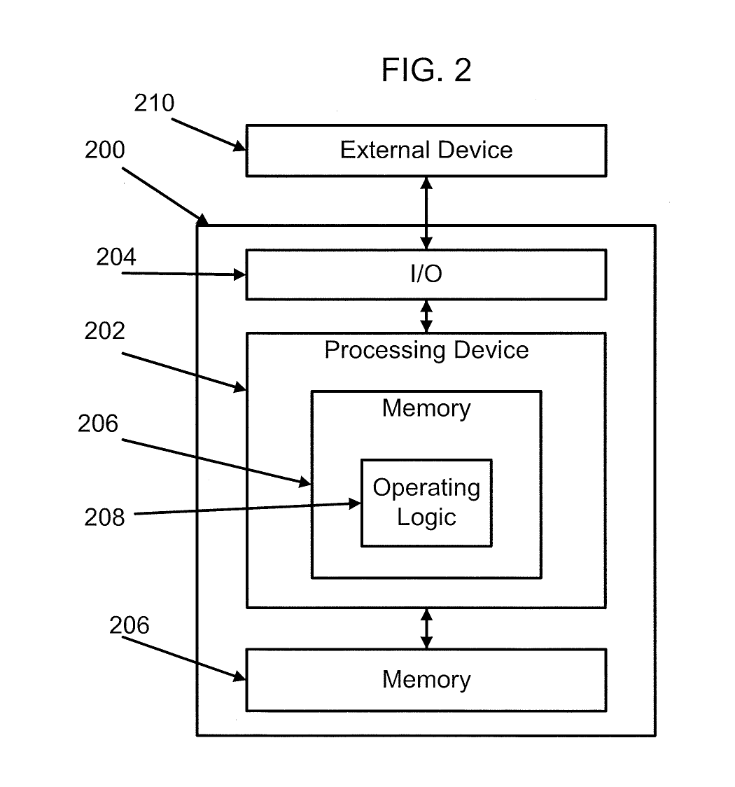

FIG. 2 is a schematic diagram of a computing device 200. The computing device 200 is one example of a computing device that may be utilized in connection with the computing device 102 and/or computing device 178 shown in FIG. 1. Computing device 200 includes a processing device 202, an input/output device 204, memory 206, and operating logic 208. In other embodiments, computing device 200 may take other forms. Furthermore, in some embodiments, computing device 200 may communicate with one or more external devices 210.

The input/output device 204 may be any type of device that allows the computing device 200 to communicate with the external device 210. For example, the input/output device 204 may be a transceiver, network adapter, network card, interface, or a port (e.g., a USB port, serial port, parallel port, an analog port, a digital port, VGA, DVI, HDMI, FireWire, CAT 5, or any other type of port or interface). The input/output device 204 may be comprised of hardware, software, firmware, and/or state machines. It is contemplated that the input/output device 204 may include more than one transceiver, network adapter, network card, or port.

The external device 210 may be any type of device that allows data to be inputted to or outputted from the computing device 200. For example, the external device 210 may be another Bluetooth system, a computer, a server, a mobile phone (e.g., a smartphone), a handheld diagnostic tool, a controller, a printer, a display, an alarm, an illuminated indicator, a keyboard, a mouse, or a touch screen display. Furthermore, it is contemplated that the external device 210 may be integrated into the computing device 200. For example, the computing device 200 may be a mobile phone, a handheld diagnostic tool, a smartphone, a laptop computer, or a tablet computer in which case the display would be an external device 210, but the display is integrated with the computing device 200 as one unit, which is consistent with the general design of mobile phones, handheld diagnostic tools, smartphones, laptop computers, tablet computers, and the like. It is further contemplated that there may be more than one external device in communication with the computing device 200. Another computing device is one example of an external device 210.

Processing device 202 can be a programmable type, a dedicated, hardwired state machine; or a combination of these; and it can further include multiple processors, Arithmetic-Logic Units (ALUs), Central Processing Units (CPUs), Digital Signal Processors (DSPs), or the like. Processing devices 202 with multiple processing units may utilize distributed, pipelined, and/or parallel processing. Processing device 202 may be dedicated to performance of just the operations described herein or may be utilized in one or more additional applications. In the depicted form, processing device 202 is of a programmable variety that executes algorithms and processes data in accordance with operating logic 208 as defined by programming instructions (such as software or firmware) stored in memory 206. Alternatively or additionally, operating logic 208 for processing device 202 is at least partially defined by hardwired logic or other hardware. Processing device 202 can be comprised of one or more components of any type suitable to process the signals received from input/output device 204 or elsewhere, and provide desired output signals. Such components may include digital circuitry, analog circuitry, or a combination of both.

Memory 206 may be of one or more types, such as a solid-state variety, electromagnetic variety, optical variety, or a combination of these forms. Furthermore, memory 206 can be volatile, nonvolatile, or a mixture of these types, and some or all of memory 206 can be of a portable variety, such as a disk, tape, memory stick, cartridge, or the like. In addition, memory 206 can store data that is manipulated by the operating logic 208 of processing device 202, such as data representative of signals received from and/or sent to input/output device 204 in addition to or in lieu of storing programming instructions defining operating logic 208, just to name one example. As shown in FIG. 2, memory 206 may be included with processing device 202 and/or coupled to the processing device 202.

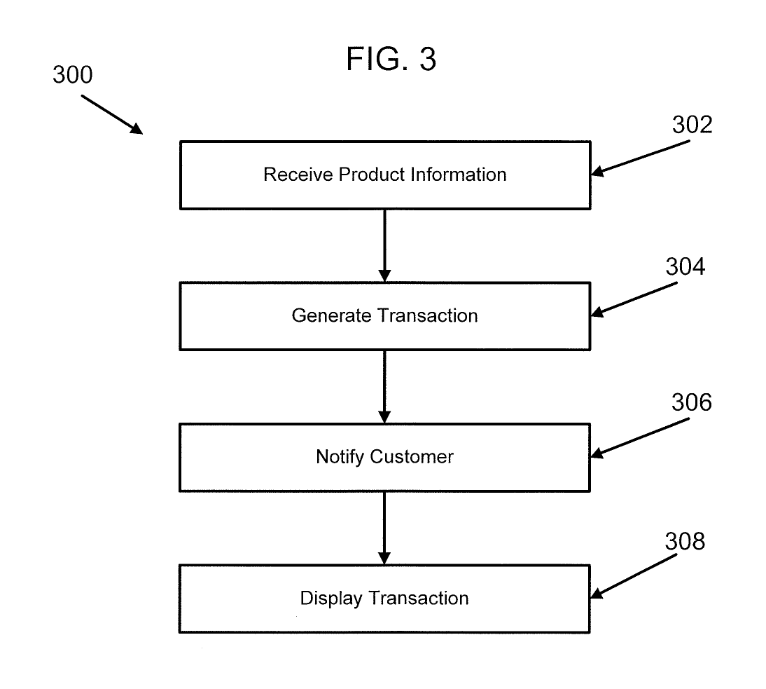

The schematic flow diagram in FIG. 3, and the related descriptions which follow, are illustrative embodiments of an exemplary process for conducting a transaction. Operations illustrated are understood to be exemplary only, and operations may be combined or divided, and added or removed, as well as re-ordered in whole or in part, unless explicitly stated to the contrary.

Process 300 may be implemented by one or more computing devices executing one or more computer programs stored on a computer readable storage medium. The computer program comprises instructions or operating logic causing the computing device to execute one or more of the operations of the process 300. In certain embodiments, the computer program may be comprised of modules, such as those described herein.

Process 300 begins at operation 302. At operation 302, information related to the purchase of products from a seller (e.g., a manufacturer) by a customer (e.g., a dealer) are received by the seller and inputted into a seller's computing device 102. For example, the computing device 102 may receive an order from a customer computing device 178. The order may be for one or more primary products. The information may include the number of primary products that the customer wishes to order.

Process 300 then proceeds from operation 302 to operation 304. At operation 304, the seller, such as the seller's computing device 102, generates a transaction that includes a bundled package and discount. In particular, the bundled package includes one or more primary products and one or more secondary products. The computing device 102 may determine one or more of the secondary products to be included in the transaction even if they were not ordered by the customer.

Furthermore, the computing device 102 may determine a discount as discussed above. In one embodiment, a discount is provided on the price of one or more of the secondary products. In another embodiment, the discount is applied to the bundled package. Referring to the calculation of the discount, in one embodiment, the amount of the discount is based upon a quantity of the primary product purchased by the customer such as a dealer. In another embodiment, the seller's computing device 102 generally calculates the discount based upon the customer's inclusion rate, among other things.

In operation 306, a notification is sent by the seller, such as the seller's computing device 102, to the customer with information regarding the transaction. For example, the notification may inform the customer that the seller has allocated a number of primary products in its inventory based on the order. As another example, the notification may include information about the transaction such as the bundled package and discount. It is contemplated that terms of the transaction may be negotiated and revised between the seller and the customer. The notification may include an email, a SMS message, a document deposited in a web portal, or any other type of notification. The notification may include the transaction 116.

In operation 308, the transaction 116 is displayed. For example, the display module 110 of the computing device 102 may display the transaction 116 on a screen of the computing device 102, email the transaction 116 to the customer computing device 178, email the transaction 116 to other computing devices at the seller, upload the transaction 116 to a web portal, print the transaction 116 and/or providing the transaction 116 to the customer in any other suitable way known to those skilled in the art. The transaction 116 may be displayed before or after the transaction 116 is agreed upon by the seller and the customer. The computing device 102 transforms the transaction 116 and converts it into a format that can be displayed on a computing device screen, printed, or displayed in other way known to those skilled in the art.

One embodiment of the present application includes a method for receiving an approval of a predetermined discount for a system component associated with a transaction, the method comprising: providing to a first instance a relational discount for one or more second devices associated with a purchase of a first device of a first quantity, wherein the second device is operable with the first device; receiving a request from the first instance to receive a first device at the first quantity; allocating to the first instance the first device at the first quantity; providing notification to the first instance of allocation of the first device of the first quantity and a discount rate for the one or more second devices; publishing a transaction reflecting terms, first quantity, and discount rate for the one or more second devices; and providing the published transaction to the first instance.

Additional features of the embodiment may include: wherein the first instance is a dealer; wherein the notification includes an email; wherein the first device includes at least one of an air conditioning unit, a furnace, and a HVAC system; wherein the second device includes at least one of a control unit, a software application to control various devices in an intelligent home system, a light unit, a bridge, an appliance unit, a dimmer unit, a lock, a keypad, a camera, a security sensor, an energy monitor unit, a router, in wall dimmer switch, a wall switch, an outdoor light unit, outlet dimmer, outlet switch, a door sensor, window sensor, a water sensor, a motion detector, motorized shades and screens, a home theatre, a keychain remote access, garage door openers, an in wall scene controller, and a remote controller; wherein the transaction further includes a six-month service subscription; wherein publishing the transaction includes at least one of emailing the transaction, displaying the transaction on a computer, and printing the transaction on paper.

Another embodiment of the present application includes a system, comprising: a first computer to generate a proposed transaction including a bundled package having at least one first device and one second device, the proposed transaction including a discount on a price of the second device based on an inclusion rate of a dealer; a second computer to receive and evaluate terms of the proposed transaction for the bundled package; and a display device to publish the proposed transaction once the transaction is agreed upon and finalized.

Yet another embodiment of the present application includes: an apparatus, comprising: a first computer including a processing device and a memory, the memory including operating logic that when executed by the processing device causes the computer to: generate a contract for the sale of a bundled package including a first product and second product; calculate a price for the bundled package including a discount based on an inclusion rate; and display the contract on a display device by transforming information for the contract into an image that is intelligible and perceptible on the display device.

Another embodiment of the present application includes a method, comprising: receiving, with a computing device, a first request from a first instance to purchase one or more first devices at a first quantity; determining, with the computing device, a first relational discount for one or more second devices associated with the purchase of the first devices at the first quantity, wherein at least one of the one or more second devices are operable with the one or more first devices; generating, with the computing device, a first transaction including the first quantity and the first relational discount for the one or more second devices; and providing, with the computing device, the first transaction to the first instance.

Additional features of the embodiment may include: wherein the first relational discount is directly proportional to the first quantity; allocating to the first instance the first devices at the first quantity; providing notification to the first instance of the allocation of the first devices at the first quantity and the first relational discount for the one or more second devices; receiving, with the computing device, a second request from a second instance to purchase one or more first devices at a second quantity; determining, with the computing device, a second relational discount for one or more second devices associated with the purchase of the first devices at the second quantity, allocating to the second instance the first devices at the second quantity; generating, with the computing device, a second transaction including the second quantity and the second relational discount for the one or more second devices; and providing, with the computing device, the second transaction to the second instance; wherein the first device includes at least one of an air conditioning unit, a furnace, and a HVAC system; wherein the second device includes at least one of a control unit, a software application to control various devices in an intelligent home system, a light unit, a bridge, an appliance unit, a dimmer unit, a lock, a keypad, a camera, a security sensor, an energy monitor unit, a router, in wall dimmer switch, a wall switch, an outdoor light unit, outlet dimmer, outlet switch, a door sensor, window sensor, a water sensor, a motion detector, motorized shades and screens, a home theatre, a keychain remote access, garage door openers, an in wall scene controller, and a remote controller; wherein the transaction further includes a six-month service subscription to utilize a remote control system configured to control at least one of the first devices and the second devices; wherein providing the first transaction includes at least one of emailing the first transaction, displaying the first transaction on the computing device or another device, depositing the first transaction in a web portal, and printing the first transaction on paper.

Yet another embodiment of the present application includes an apparatus, comprising: a computing device including an input module, a calculation module, and a display module, wherein the input module is configured to receive a first order from a first customer to purchase one or more first devices at a first quantity, wherein the calculation module is configured to determine a first discount rate for a first package of one or more second devices associated with the purchase of the first devices at the first quantity, wherein the calculation module is further configured to generate a first transaction including the first quantity and the first discount rate for the one or more second devices, and wherein the display module is configured to provide the first transaction to the first customer.

Additional features of the embodiment may include: wherein the calculation module of the computing device is further configured to allocate to the first customer the first devices at the first quantity; wherein the display module is further configured to notify the first customer of the allocation and of the first discount rate; wherein the input module is further configured to receive a second request from a second customer to purchase one or more first devices at a second quantity, wherein the calculation module is further configured to determine a second discount rate for a second package of one or more second devices associated with the purchase of the first devices at the second quantity, allocating to the second instance the first devices at the second quantity, wherein the calculation module is further configured to generate a second transaction including the second quantity and the second discount rate for the one or more second devices, and wherein the display module is further configured to provide the second transaction to the second customer; wherein providing the first transaction includes at least one of emailing the first transaction, displaying the first transaction on the computing device or another device, depositing the first transaction in a web portal, and printing the first transaction on paper; wherein the first discount rate is directly proportional to the first quantity.

Another embodiment of the present application includes a method, comprising: receiving an order to purchase at least one or more first devices; determining a bundle including the one or more first devices and a plurality of second devices; determining a discount for at least a portion of the bundle that is directly proportional to a number of first devices to be purchased; generating a transaction including the bundle and the discount; and displaying the transaction.

Additional features of the present application may include: managing manufacturing and inventory based on the number of first devices in the order; allocating a portion of the inventory based on the number of first devices in the order; increasing manufacturing output of first devices based on the number of first devices in the order; and/or wherein the discount is applied to a cost of the second devices.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method, comprising:
receiving, with a computing device, a first request from a first instance to purchase one or more first devices at a first quantity;
determining, with the computing device, a first relational discount for one or more second devices associated with the purchase of the first devices at the first quantity, wherein at least one of the one or more second devices are operable with the one or more first devices;
generating, with the computing device, a first transaction including the first quantity and the first relational discount for the one or more second devices; and
providing, with the computing device, the first transaction to the first instance.

2. The method of claim 1, wherein the first relational discount is directly proportional to the first quantity.

3. The method of claim 1, further comprising:
allocating to the first instance the first devices at the first quantity.

4. The method of claim 3, further comprising:
providing notification to the first instance of the allocation of the first devices at the first quantity and the first relational discount for the one or more second devices.

5. The method of claim 3, further comprising:
receiving, with the computing device, a second request from a second instance to purchase one or more first devices at a second quantity;
determining, with the computing device, a second relational discount for one or more second devices associated with the purchase of the first devices at the second quantity,
allocating to the second instance the first devices at the second quantity;
generating, with the computing device, a second transaction including the second quantity and the second relational discount for the one or more second devices; and
providing, with the computing device, the second transaction to the second instance.

6. The method of claim 1, wherein the first device includes at least one of an air conditioning unit, a furnace, and a HVAC system.

7. The method of claim 1, wherein the second device includes at least one of a control unit, a software application to control various devices in an intelligent home system, a light unit, a bridge, an appliance unit, a dimmer unit, a lock, a keypad, a camera, a security sensor, an energy monitor unit, a router, in wall dimmer switch, a wall switch, an outdoor light unit, outlet dimmer, outlet switch, a door sensor, window sensor, a water sensor, a motion detector, motorized shades and screens, a home theatre, a keychain remote access, garage door openers, an in wall scene controller, and a remote controller.

8. The method of claim 1, wherein the transaction further includes a six-month service subscription to utilize a remote control system configured to control at least one of the first devices and the second devices.

9. The method of claim 1, wherein providing the first transaction includes at least one of emailing the first transaction, displaying the first transaction on the computing device or another device, depositing the first transaction in a web portal, and printing the first transaction on paper.

10. An apparatus, comprising:
a computing device including an input module, a calculation module, and a display module, wherein the input module is configured to receive a first order from a first customer to purchase one or more first devices at a first quantity, wherein the calculation module is configured to determine a first discount rate for a first package of one or more second devices associated with the purchase of the first devices at the first quantity, wherein the calculation module is further configured to generate a first transaction including the first quantity and the first discount rate for the one or more second devices, and wherein the display module is configured to provide the first transaction to the first customer.

11. The apparatus of claim 10, wherein the calculation module of the computing device is further configured to allocate to the first customer the first devices at the first quantity.

12. The apparatus of claim 11, wherein the display module is further configured to notify the first customer of the allocation and of the first discount rate.

13. The apparatus of claim 11, wherein the input module is further configured to receive a second request from a second customer to purchase one or more first devices at a second quantity, wherein the calculation module is further configured to determine a second discount rate for a second package of one or more second devices associated with the purchase of the first devices at the second quantity, allocating to the second instance the first devices at the second quantity, wherein the calculation module is further configured to generate a second transaction including the second quantity and the second discount rate for the one or more second devices, and wherein the display module is further configured to provide the second transaction to the second customer.

14. The apparatus of claim 10, wherein providing the first transaction includes at least one of emailing the first transaction, displaying the first transaction on the computing device or another device, depositing the first transaction in a web portal, and printing the first transaction on paper.

15. The apparatus of claim 10, wherein the first discount rate is directly proportional to the first quantity.

16. A method, comprising:
receiving an order to purchase at least one or more first devices;
determining a bundle including the one or more first devices and a plurality of second devices;
determining a discount for at least a portion of the bundle that is directly proportional to a number of first devices to be purchased;
generating a transaction including the bundle and the discount; and
displaying the transaction.

17. The method of claim 16, further comprising:
managing manufacturing and inventory based on the number of first devices in the order.

18. The method of claim 17, further comprising:
allocating a portion of the inventory based on the number of first devices in the order.

19. The method of claim 18, further comprising:
increasing manufacturing output of first devices based on the number of first devices in the order.

20. The method of claim 16, wherein the discount is applied to a cost of the second devices.
